(19) United States
(12) Patent Application Publication
(10) Pub. No.: US 2016/0135501 A1
(43) Pub. Date: May 19, 2016

(54) SIMULATED CIGARETTE

(71) Applicant: Qiuming LIU, GUANGDONG (CN)

(72) Inventor: Qiuming LIU, GUANGDONG (CN)

(21) Appl. No.: 13/392,092

(22) PCT Filed: Dec. 21, 2011
(86) PCT No.: PCT/CN2011/084391

§ 371 Date: Dec. 8, 2015

(51) Int. Cl. A24F 47/00; H05B 1/02; H05B 3/80; F22B 1/28

(52) U.S. Cl. CPC A24F 47/008; F22B 1/284; H05B 1/0297; H05B 3/80

(57) ABSTRACT

The present invention relates to a simulated cigarette, which includes a gas tank set in a shell for storing gas of cigarette-smoking flavor in a liquefied-gas phase. The gas tank has a valve device set thereto for controlling the gas of cigarette-smoking flavor in and out. The simulated cigarette further includes a heat device for heating up the gas of cigarette-smoking flavor emitted from the gas tank, and accordingly a controlling unit and a power source set in the shell. The shell of the simulated cigarette has an integrated or parted structure. The gas tank is detachably set in the shell. The present invention mainly resolves fluid-leaking problem in the prior art. The simulated cigarette of the present invention has good leakage-proof performance. The simulated cigarette emits out gas tasted as cigarette-smoking flavor so that it can be used right after switched on.

### BACKGROUND OF THE INVENTION

The present invention relates to a kind of simulated cigarette, especially to a kind of simulated cigarette in which the stored gas in a scent taste that mimics cigarette smoking are pressed into liquefied-gas phase.

The existing electronic cigarette has a leading part to lead the solid or liquid scent media in a reservoir to an atomizer so as to vaporize the solid or liquid scent media into vapor mists to be inhaled by the user.

However, the existing electronic cigarette has such drawbacks as: liquid scent media in storage or in use has fluid-leaking problem at the liquid outlet or where the leading part connects with the reservoir; the solid scent media in use will be preheated to liquid phase, and cause fluid-leaking problem as well; furthermore, it needs an atomizing device to atomize or inflame the solid or liquid scent media into scent vapor for smoking, therefore, if power source is absent, the solid or liquid scent media cannot be atomized or inflamed, then smoking is impossible.

### BRIEF SUMMARY OF THE INVENTION

A main object of the present invention is to provide a simulated cigarette, which has good leakage-proof performance.

To obtain the above object, a simulated cigarette comprises a shell, further comprises a gas tank set in the shell for storing gas of cigarette-smoking flavor, in which gas is pressed into a liquefied-gas phase in advance. A valve device is set to the gas tank for controlling gas of cigarette-smoking flavor in and out.

Furthermore, the simulated cigarette further comprises a heat device inside the shell for heating up the gas of cigarette-smoking flavor emitted from the gas tank, and accordingly comprises a controlling unit and a power source set inside the shell.

Furthermore, the heat device comprises a heat wire and a support seat for holding the heat wire and for heat insulation, and the heat wire is set inside the shell via the support seat.

Furthermore, the power source is a kind of dry battery or a kind of rechargeable storage battery.

Furthermore, the shell of the simulated cigarette has an integrated structure.

Furthermore, the simulated cigarette has a parted structure, and comprises a front shell and a rear shell releasably engaged with each other; and each of the front shell and rear shell is hollow.

Furthermore, the gas tank is detachably mounted in the front shell or in the rear shell.

Furthermore, a mouthpiece is set to the shell of the simulated cigarette which is intercommunicated with an inner chamber of the shell for gas of cigarette-smoking flavor passing through.

Furthermore, the valve device is a kind of automatically operated valve set inside the shell.

Furthermore, the valve device is a kind of hand operated valve set to the shell; and the hand operated valve is a hand-operated mechanical valve or a hand-operated electric valve.

The present invention has such advantages as: the simulated cigarette has a gas tank for storing gas of cigarette-smoking flavor, the gas is pressed into a liquefied-gas phase in advance in the gas tank, and is controlled to be in and out by a valve device set to the gas tank, such that the simulated cigarette has good leakage-proof performance, has no problems of fluid leaking, reversing, or burning. Inside the shell is set a heat device for heating up the gas, so that the user feels more like cigarette smoking. If the shell is designed as a parted structure, the gas tank is detachably mounted in the shell, and the simulated cigarette can be recycling. The gas with cigarette-smoking flavor of the simulated cigarette is emitted out, it is not necessary to be atomized or inflamed, and thus the simulated cigarette can be used right after being switched open. The user will not worry about failing to flame, and smoking is possible even in raining.

A further detailed description to the present invention follows with reference to the accompanying drawings.

### BRIEF DESCRIPTION OF THE DRAWINGS

FIG. 1 is a schematic view of a simulated cigarette in accordance with a first embodiment of the present invention.

FIG. 2 is a schematic view of a simulated cigarette in accordance with a second embodiment of the present invention.

FIG. 3 is a schematic view of a simulated cigarette in accordance with a third embodiment of the present invention.

FIG. 4 is a schematic view of a simulated cigarette in accordance with a fourth embodiment of the present invention.

FIG. 5 is a schematic view of a simulated cigarette in accordance with a fifth embodiment of the present invention.

FIG. 6 is a schematic view of a simulated cigarette in accordance with a sixth embodiment of the present invention.

FIG. 7 is a schematic view of a simulated cigarette in accordance with a seventh embodiment of the present invention.

### DETAILED DESCRIPTION OF THE INVENTION

Referring to FIG. 1, a simulated cigarette I of the present invention in accordance with the first embodiment, comprises a shell 11, gas tank 12, valve device 13 and mouthpiece 14. The shell 11 has an integrated structure. The gas tank 12 is prefilled with gas in liquefied-gas phase and of cigarette-smoking flavor, such as tobacco flavor, mint flavor, fruit flavor, combination flavor, or other flavors which mimics cigarette smoking. The gas tank 12 is defined within the shell 11 as an integrated structure. And the gas tank 12 is irreplaceable. Therefore, the simulated cigarette I in the first embodiment is disposable. The valve device 13 is positioned at one end of the gas tank 12, and is a kind of hand operated valve, such as hand-operated mechanical valve or hand-operated electric valve. A press button of the hand operated valve device extends to outer wall of the shell 11. When press the press button by hand, the gas with cigarette-smoking flavor in the tank 12 is emitted out to an inner chamber of the shell 12. The mouthpiece 14 is set to shell 11, and intercommunicates with the inner chamber of the shell 11. The gas with cigarette-smoking flavor flows from the inner chamber of the shell 11, through the mouthpiece 14 to outer of the shell 11, or is inhaled by the user. The gas with cigarette-smoking flavor emitted from the tank 12 is not heated it keeps at a room temperature.

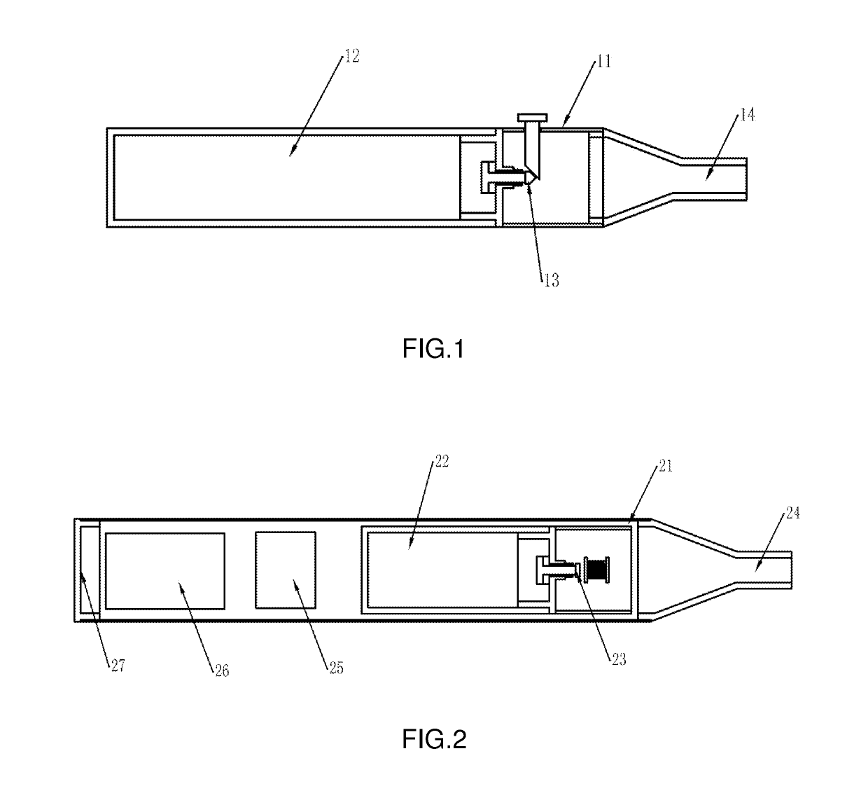

Referring to FIG. 2, a simulated cigarette II of the present invention in accordance with the second embodiment, comprises a shell 21, gas tank 22, valve device 23, mouthpiece 24, controlling unit 25, power source 26, and cap 27. The shell 21 has an integrated structure. The gas tank 22 is prefilled with gas in liquefied-gas phase which has a flavor mimicing cigarette smoking. The gas tank 22 is mounted inside the shell 21. The valve device 23 is positioned at the gas-outlet end of the gas tank 22, and is a kind of automatically operated valve, such as a kind of electromagnetic valve. The valve device 23 is electrically connected with the controlling unit 25 to control the valve device 23 switching on and off so that the gas with the cigarette-smoking flavor in the tank 22 will be emitted out to an inner chamber of the shell 21. The mouthpiece 14 is set to shell 21, and intercommunicates with the inner chamber of the shell 21. The gas with cigarette-smoking flavor flows from the inner chamber of the shell 21, through the mouthpiece 24 to outer of the shell 21, or is inhaled by the user. The gas with cigarette-smoking flavor emitted from the tank 22 is not heated so that it keeps at a room temperature as well. The controlling unit 25 is mounted inside the shell 21 for controlling the valve device 23 switching on and off. The power source 26 is mounted inside the shell 21 to supply electric power to the controlling unit 23. The cap 27 is set to the end of the shell 21 for sealing the gas tank 22, controlling unit 25, and the power source 26 inside the shell 21. The gas tank 22 is irreplaceable, thus the simulated cigarette II in the second embodiment is disposable.

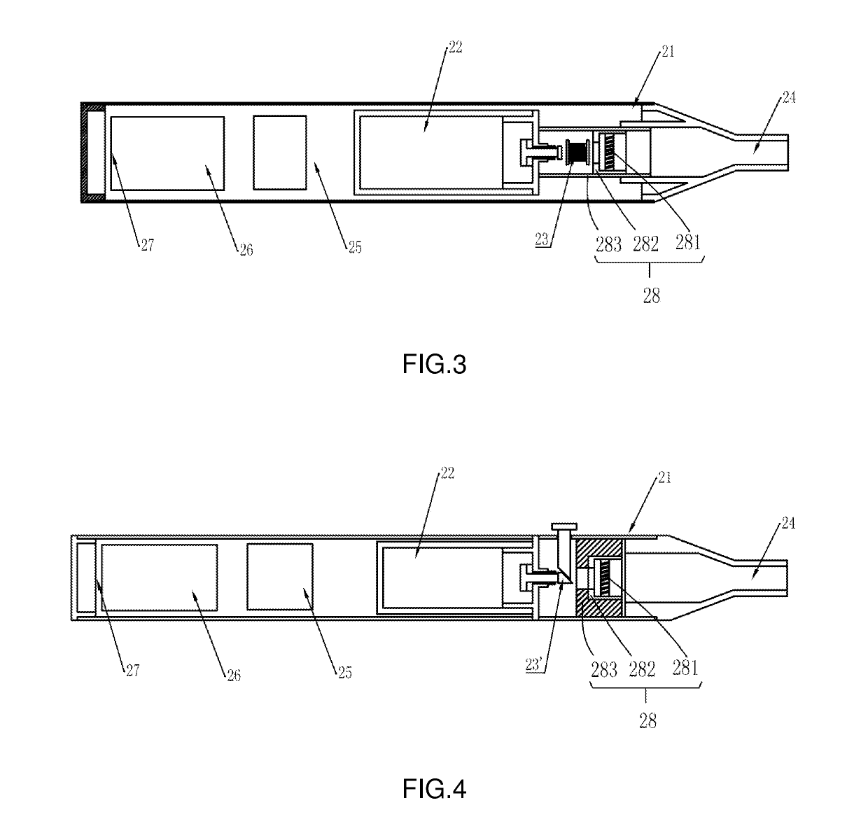

Referring to FIG. 3, a simulated cigarette III in accordance with the third embodiment is similar to the simulated cigarette II in accordance with the second embodiment, and the difference is that the simulated cigarette III further comprises a heat device 28 set inside the shell 21. The heat device 28 is used for heating up the gas with cigarette-smoking flavor emitted out from the gas tank 22, such that the gas keeps at a certain temperature, which make the user feel more like smoking cigarette. The heat device 28 further comprises an electric heat wire 281, support seat 282 and insulating piece 283. The electric heat wire 281 is held in the support seat 282, is electrically associated with the controlling unit 25, and is powered by the power source 26. The support seat 282 is fixed in the shell 21 by the insulating piece 283. The simulated cigarette III in the third embodiment is disposable as well.

Referring to FIG. 4, a simulated cigarette IV in accordance with the fourth embodiment is similar to the simulated cigarette, and the difference is that the valve device 23′ is a kind of hand operated valve. A press button of the valve device 23′ extends to the outer wall of the shell 21. The gas tasted as cigarette-smoking flavor stored in the gas tank 22 is emitted into the inner chamber of the shell 21, when the press button of the hand operatd valve is operated by hand. The simulated cigarette IV is disposable as well.

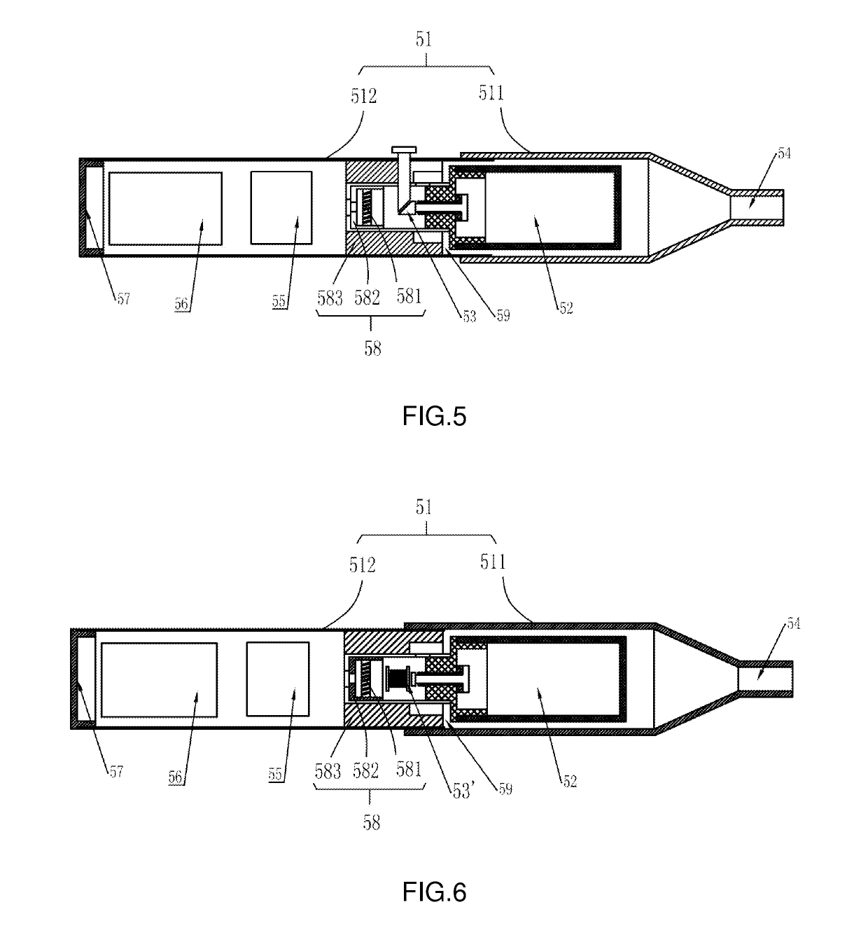

Referring to FIG. 5, a simulated cigarette V in accordance with the fifth embodiment comprises a shell 51, gas tank 52, valve device 53, mouthpiece 54, controlling unit 55, power source 56, cap 57, heat device 58, and gas-flow passage 59. The simulated cigarette V has a structure mainly similar to the cigarette IV. The difference is that the shell 51 has a parted structure, which comprises front shell 511 and rear shell 512. Each of the front shell 511 and rear shell 512 respectively has hollow chamber intercommunicated therebetween. The front shell 511 and the rear shell 512 are releasably connected. The connection means therebetween is threaded connection or clamping connection. The gas tank 52 is detachably mounted in the front shell 511 or in the rear shell 512. The gas tank 52 is replaceable, if the gas tasted as cigarette-smoking flavor stored therein exhausts, thus the gas tank 52 can be replaced, or can be refilled through the valve device 53. The front shell 511 is detached away from the rear shell 512 so that the gas tank 52 can be replaced. The valve device 53 of the simulated cigarette V is a kind of hand operated valve, the press button of the hand operated valve extends to the outer wall of the rear shell 512. Press the press button by hand so that the gas tasted as cigarette-smoking flavor stored in the gas tank 52 is emitted to the inner chamber of the shell 52. The mouthpiece 54 is set to the front shell 511 and intercommunicates with the inner chamber of the front shell 511. The controlling unit 55, power source 56, and the cap 57 are set inside the rear shell 512. The heat device 58 comprises electric heat wire 581, support seat 582 and insulating piece 583. The electric heat wire 581 is held in the support seat 582, and is electrically associated with the controlling unit 55 and is powered by the power source 26. The support seat 582 is fixed in the rear shell 512 by the insulating piece 583. The insulating piece 583 defines a groove communicating with the gas-flow passage 59. The valve device 53 in accordance with this embodiment is set to direct to the rear shell 512, so that the gas tasted as cigarette-smoking flavor is emitted through the mouthpiece 54 to outside of the front shell 511 or to the mouth of the user. The gas-flow passage 59 is defined in the shell 511, and is communicated with the inner chamber of the front shell 511. The shell 51 has a parted structure, and the gas tank 52 is detachably mounted in the shell 51, the gas tank 52 is replaceable as well. Therefore, the simulated cigarette V can be periodically used.

Referring to FIG. 6, a simulated cigarette VI in accordance with the sixth embodiment is mainly similar to the cigarette V. The difference is that the valve device 53′ is a kind of automatically operated valve, which is electrically associated with the controlling unit 55. The controlling unit 55 controls the valve device 53′ switching on and off so that the gas tasted as cigarette-smoking flavor stored in the gas tank 52 is emitted into the inner chamber of the shell 51. The simulated cigarette VI can be periodically used as well.

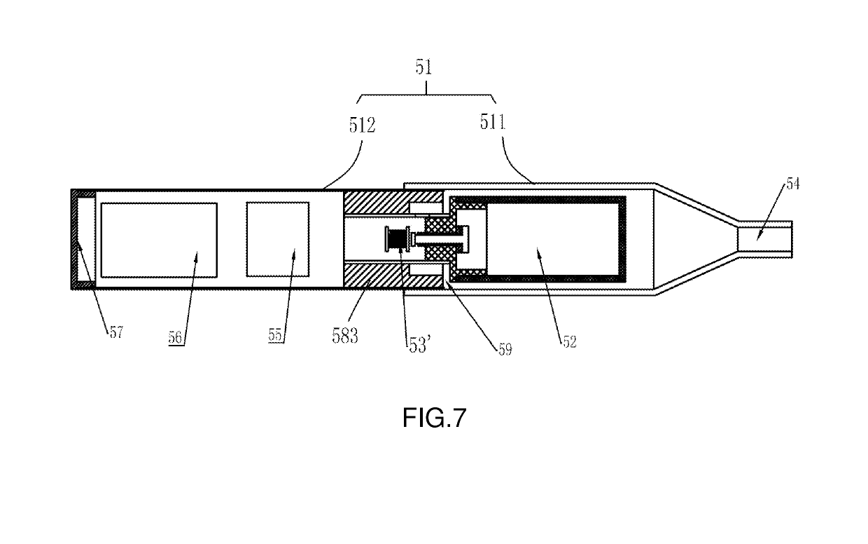

Referring to FIG. 7, the simulated cigarette VII in accordance with the seventh embodiment is mainly the same as the simulated cigarette VI, and the difference is that the simulated cigarette VII is not set with electric heat wire 581 and support seat 582, but retains the insulating piece 583 for holding the valve device 53′. The simulated cigarette VII can be periodically used as well. Since the gas tasted as cigarette-smoking flavor emitted out from the gas tank 22 is not heated up, the gas tasted as cigarette-smoking flavor keeps at room temperature.

In the view of disclosure to the embodiments of the present invention, it will be apparent to one skilled in the art that modifications and/or substitutes may be made without departing from the scope and spirit of the invention.

1. A simulated cigarette comprising a shell, wherein the simulated cigarette further comprises a gas tank set in the shell for storing gas of cigarette-smoking flavor which is pressed into a liquefied-gas phase; a valve device is set to the gas tank for controlling the gas of cigarette-smoking flavor in and out.

2. The simulated cigarette according to claim 1, wherein the simulated cigarette further comprises a heat device inside the shell for heating up the gas of cigarette-smoking flavor emitted from the gas tank, and accordingly comprises a controlling unit and a power source set inside the shell.

3. The simulated cigarette according to claim 2, wherein the heat device comprises a heat wire and a support seat for holding the heat wire and for heat insulation, and the heat wire is set inside the shell via the support seat.

4. The simulated cigarette according to claim 2, wherein the power source is a kind of dry battery or a kind of rechargeable storage battery.

5. The simulated cigarette according to claim 1, wherein the shell of the simulated cigarette has an integrated structure.

6. The simulated cigarette according to claim 1, wherein the simulated cigarette has a parted structure, and comprises a front shell and a rear shell releasably engaged with each other; and each of the front shell and rear shell is hollow.

7. The simulated cigarette according to claim 6, wherein the gas tank is detachably mounted in the front shell or in the rear shell.

8. The simulated cigarette according to claim 1, wherein a mouthpiece is set to the shell of the simulated cigarette, which is intercommunicated with an inner chamber of the shell for the gas of cigarette-smoking flavor passing through.

9. The simulated cigarette according to claim 14, wherein the valve device is a kind of automatically operated valve set inside the shell.

10. The simulated cigarette according to claim 14, wherein the valve device is a kind of hand operated valve set to the shell; and the hand operated valve is a hand-operated mechanical valve or a hand-operated electric valve.
